(19) United States
(12) Patent Application Publication
(10) Pub. No.: US 2026/0168173 A1
(43) Pub. Date: Jun. 18, 2026

(54) METHOD OF MANUFACTURING A FILM COMPRISING HIGHLY REFINED CELLULOSE FIBERS

(71) Applicant: Stora Enso OYJ, Helsinki (FI)

(72) Inventors: Pekka Kylliäinen, Imatra (FI); Isto Heiskanen, Imatra (FI)

(73) Assignee: Stora Enso OYJ, Helsinki (FI)

(21) Appl. No.: 19/128,840

(22) PCT Filed: Oct. 30, 2023
(86) PCT No.: PCT/IB2023/060911

§ 371 Date: May 9, 2025

(30) Foreign Application Priority Data
Nov. 11, 2022 (SE) 2230360-6

(51) Int. Cl. D21F 11/14; D21F 3/02

(52) U.S. Cl. CPC D21F 11/14; D21F 3/0218

(57) ABSTRACT

The present invention relates to a method for manufacturing a film comprising highly refined cellulose fibers in a paper-making machine, the method comprising the steps of: a) forming a wet web by applying a pulp suspension comprising at least 50% b dry weight of highly refined cellulose fibers having a Schopper-Riegler (SR) value in the range of 80-100 from a headbox onto a moving wire and partially dewater the web on the wire; and b) feeding the partially dewatered web from the wire into a dewatering nip formed between a suction roll and a lump breaker roll to further dewater the wet web, c) optionally further dewatering the web from the dewatering nip in a press section and drying the web in a drying section to obtain a film comprising the highly refined cellulose fibers.

### TECHNICAL FIELD

The present disclosure relates to gas barrier films, e.g. useful in paper and paperboard based packaging materials. More specifically, the present disclosure relates to methods for manufacturing films comprising highly refined cellulose fibers, particularly films comprising microfibrillated cellulose (MFC).

### BACKGROUND

Effective gas, aroma, and/or moisture barriers are required in packaging industry for shielding sensitive products. Particularly, oxygen-sensitive products require an oxygen barrier to extend their shelf-life. Oxygen-sensitive products include many food products, but also pharmaceutical products and electronic industry products. Known packaging materials with oxygen barrier properties may be comprised of one or several polymer films or of a fibrous paper or board coated with one or several layers of an oxygen barrier polymer, usually as part of a multilayer coating structure. Another important property for packaging for food products is resistance to grease and oil.

More recently, microfibrillated cellulose (MFC) films have been developed, in which defibrillated cellulosic fibrils have been suspended e.g. in water, re-organized and rebonded together to form a continuous film. MFC films have been found to provide good gas barrier properties as well as good resistance to grease and oil.

MFC films or substrates may be made by use of casting technologies, including applying an MFC dispersion onto a non-porous cast surface or substrate, such as a polymeric or metal substrate, and drying said film by evaporation. The advantages of this technology include uniform thickness distribution and a smooth surface of the film. The publication EP2771390 A4 describes preparation of MFC films, in which an aqueous cellulose nanofiber dispersion is coated on a paper or polymeric substrate, dried and finally peeled off as a nanofiber film sheet.

A problem connected with the casting process is that when the film is forming in the drying step, the slow diffusion of water restricts the drying rate. The diffusion of water vapor through the film is a slow process which has a negative impact on the process efficiency. If the drying speed is increased, pinholes may be formed in the film, deteriorating its barrier properties. A further problem with the casting process is the formation of shrink tensions in the formed film which may have a negative impact on its strength properties, such as strain at break or tensile strength.

MFC films or substrates may also be manufactured by methods similar to conventional paper making, preferably in a machine of the Fourdrinier type, wherein an aqueous suspension comprising MFC is applied on a wire to form a web. The web is dewatered on the wire and thereafter transferred to a press section where the web is pressed to remove additional water, and finally to a drying section where the web is dried to obtain the MFC film or substrate. This type of manufacturing has been schematically described for example in FIG. 1a of patent publication WO2014091413.

Manufacturing of films and barrier substrates from highly refined cellulose or suspension with very high drainage resistance is difficult on a paper-making machine since webs comprising high amount of MFC are difficult to dewater. There is a limit to how high vacuum that can be applied in the vacuum rolls in the wire sections, since if too high vacuum is applied, microscopic holes known as pinholes may appear in the web. Examples of reasons for the appearance of pinholes include irregularities in the pulp suspension, e.g. flocculation or re-flocculation of fibrils, rough dewatering fabric, uneven pulp distribution on the wire, too low web grammage. Pinhole formation typically increases with increased dewatering speed. In pinhole free areas, the Oxygen Transmission Rate value is good when grammage is above 20-40 g/m².

Another problem often experienced when processing MFC films in paper-making machines is that the wet web sticks to the rolls of the press section, in some cases causing fibrils to be drawn from the web and deposited on the rolls. This is also referred to as fiber/fibril picking. Fiber/fibril picking is a common problem in the manufacture of MFC films in paper machines. This issue leads to inferior runnability of the paper machine, specks and holes in the final film, as well as formation of sticky deposits on the rolls and production downtime due to cleaning of equipment.

There is further a limitation on how high pressure that can be used in the press section, since the wet, thin web can be easily broken if using too high press loads.

From a technical and economical point of view, it would be preferable to find an improved method which allows for manufacture of films or substrates comprising highly refined cellulose fibers, such as MFC films or substrates, in a paper-making machine type of process, which reduces or eliminates the problems with fiber/fibril picking and pinhole formation.

### DESCRIPTION OF THE INVENTION

It is an object of the present disclosure to provide a method for manufacturing a film comprising highly refined cellulose fibers, such as microfibrillated cellulose (MFC), which alleviates at least some of the above-mentioned problems associated with prior art methods.

It is a further object of the present disclosure to provide an improved method for manufacturing a film comprising highly refined cellulose fibers in a paper-making machine type of process.

It is a further object of the present disclosure to provide a method for manufacturing a film comprising highly refined cellulose fibers with reduced pinhole formation in the web.

It is a further object of the present disclosure to provide a method for manufacturing a film comprising highly refined cellulose fibers with reduced fiber/fibril picking.

The above-mentioned objects, as well as other objects as will be realized by the skilled person in the light of the present disclosure, are achieved by the various aspects of the present disclosure.

According to a first aspect illustrated herein, there is provided a method for manufacturing a film comprising highly refined cellulose fibers in a paper-making machine, the method comprising the steps of:
a) forming a wet web by applying a pulp suspension comprising at least 50% by dry weight of highly refined cellulose fibers having a Schopper-Riegler (SR) value in the range of 80-100 from a headbox onto a moving wire and partially dewatering the web on the wire; and
b) feeding the partially dewatered web from the wire into a dewatering nip formed between a suction roll and a lump breaker roll to further dewater the wet web,
c) optionally further dewatering the web from the dewatering nip in a press section and drying the web in a drying section to obtain a film comprising the highly refined cellulose fibers.

The inventive method allows for improved manufacturing of a film comprising highly refined cellulose fibers in a paper-making machine type of process. The invention is based on the inventive realization that feeding the partially dewatered web from the wire into a dewatering nip formed between a suction roll, also referred to as the couch roll, and a lump breaker roll at the end of the wire allows for a significant increase of the solid content of the web, without excessive fiber/fibril picking and pinhole formation. The combination of a suction roll and a lump breaker roll at the end of the wire gives rise to a stronger and denser web with less pinholes and better barrier properties. A higher solid of the web when entering the press section, as enabled by the combination of a suction roll and a lump breaker roll at the end of the wire, allows for the use of higher press loads in the press section without crushing the sheet and leads to less problems with shrinkage in the following drying. This results in improved profiles and quality of the film. Alternatively, the wire speed can be kept higher. The web will then be more wet at the end of the wire, but because of the lump breaker, the same solids after the wire section and close to the same solids after press section can be obtained as with lower speed. The higher machine speed thus leads to improved production speed. In some cases the inventive method may be used to achieve an improvement which is a compromise between quality and production speed.

The term film as used herein refers generally to a thin continuous sheet formed material. Depending on the composition of the pulp suspension, the film can also be considered as a thin paper or even as a membrane.

The pulp suspension applied in step a) is an aqueous suspension comprising a water-suspended mixture of cellulose based fibrous material and optionally non-fibrous additives. The inventive method uses pulp suspensions comprising highly refined cellulose fibers. Refining, or beating, of cellulose pulps refers to mechanical treatment and modification of the cellulose fibers in order to provide them with desired properties. The pulp suspension applied in step a) comprises at least 50% by dry weight of highly refined cellulose fibers. The term highly refined cellulose fibers as used herein preferably refers to refined cellulose fibers having a Schopper-Riegler (SR) value in the range of 80-100, preferably in the range of 80-98, more preferably in the range of 85-98, as determined by standard ISO 5267-1.

The highly refined cellulose fibers can be produced from different raw materials, for example bleached or unbleached softwood pulp or hardwood pulp. In some embodiments, the highly refined cellulose fibers are be produced from unbleached kraft pulp. The highly refined cellulose fibers are preferably never dried cellulose fibers. In some embodiments, the highly refined cellulose fibers are native highly refined cellulose fibers.

The highly refined cellulose fibers of the pulp suspension have an SR value in the range of 80-100, as determined by standard ISO 5267-1. In some embodiments, the highly refined cellulose fibers of the pulp suspension have an SR value in the range of 80-98, preferably in the range of 85-98, as determined by standard ISO 5267-1.

In some embodiments, the highly refined cellulose fibers have a water retention value (WRV) of at least 2.0 g/g, preferably at least 2.2 g/g.

The dry solids content of the pulp suspension may be comprised solely of the highly refined cellulose fibers, or it can comprise a mixture of highly refined cellulose fibers and other ingredients or additives. The pulp suspension preferably includes highly refined cellulose fibers as its main component based on the total dry weight of the pulp suspension. The pulp suspension comprises at least 50% by dry weight, preferably at least 70% by dry weight, more preferably at least 80% by dry weight or at least 90% by dry weight of the highly refined cellulose fibers, based on the total dry weight of the pulp suspension.

In some embodiments, the highly refined cellulose fibers of the pulp suspension is refined Kraft pulp. Refined Kraft pulp will typically comprise at least 10% by dry weight of hemicellulose. Thus, in some embodiments the pulp suspension comprises hemicellulose at an amount of at least 10% by dry weight, such as in the range of 10-25% by dry weight, of the amount of the highly refined cellulose fibers.

The pulp suspension may further comprise additives such as native starch or starch derivatives, cellulose derivatives such as sodium carboxymethyl cellulose, fillers, retention and/or drainage chemicals, flocculation additives, deflocculating additives, dry strength additives, softeners, cross-linking aids, sizing chemicals, dyes and colorants, wet strength resins, fixatives, de-foaming aids, microbe and slime control aids, or mixtures thereof. The pulp suspension may further comprise additives that will improve different properties of the mixture and/or the produced film such as latex and/or polyvinyl alcohol (PVOH) for enhancing the ductility of the film.

In some embodiments, the highly refined cellulose fibers is microfibrillated cellulose (MFC).

Microfibrillated cellulose (MFC) shall in the context of the patent application be understood to mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin.

MFC can be produced from wood cellulose fibers, both from hardwood and softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physical or physical-chemical properties such as its large surface area or its ability to form a gel-like material at low solids (1-5 wt %) when dispersed in water.

The dry solids content of the pulp suspension may be comprised solely of MFC, or it can comprise a mixture of MFC and other ingredients or additives. The pulp suspension preferably includes MFC as its main component based on the total dry weight of the pulp suspension. In some embodiments, the pulp suspension comprises 50-99% by dry weight, preferably 70-99% by dry weight, more preferably 80-99% by dry weight of MFC, based on the total dry weight of the pulp suspension.

In addition to the highly refined cellulose fibers, the pulp suspension may also comprise a certain amount of unrefined or slightly refined fibers. The unrefined or slightly refined fibers can be made of same fiber source as the highly refined cellulose fibers, e.g. bleached or unbleached softwood or hardwood pulp. But the unrefined or slightly refined fibers can also be made from other sources such as mechanical fibers, e.g. CTMP, or even from synthetic fibers such as PVOH or PLA fibers. The term unrefined or slightly refined fibers as used herein preferably refers to fibers having a Schopper-Riegler (SR) value below 30, preferably below 28, as determined by standard ISO 5267-1.

Unrefined or slightly refined cellulose fibers are useful to enhance dewatering and may also improve strength and fracture toughness of the film. In some embodiments, the pulp suspension comprises 0.1-50% by dry weight, preferably 0.1-30% by dry weight, and more preferably 0.1-10% by dry weight of unrefined or slightly refined cellulose fibers, based on the total dry weight of the pulp suspension. The unrefined or slightly refined cellulose fibers may for example be obtained from bleached or unbleached or mechanical or chemimechanical pulp or other high yield pulps. The unrefined or slightly refined cellulose fibers are preferably never dried cellulose fibers.

In some embodiments, the SR value of the pulp suspension including also other ingredients or additives is in the range of 30-90, preferably in the range of 40-90 or in the range of 50-90.

The inventive method is performed in a paper-making machine, more preferably in a Fourdrinier paper machine, optionally equipped with a hybrid former. A paper-making machine (or paper machine) is an industrial machine which is used in the pulp and paper industry to create paper in large quantities at high speed. Modern paper-making machines are typically based on the principles of the Fourdrinier machine, which uses a moving woven mesh, a so-called “wire”, to create a continuous web by filtering out the fibrous material held in a pulp suspension and producing a continuously moving wet web of fiber. This wet web is then typically dried in the machine to produce a strong paper web or film.

The forming and dewatering steps of the inventive method are performed at the forming section of the paper machine, commonly called the wet end. The wet web is formed on the wire in the forming section of the paper machine.

The pulp suspension is applied to the wire using a headbox. The function of the headbox is to dose and distribute the pulp suspension uniformly across the width of the wire. In the headbox, the pulp suspension pumped in a pipe is converted to a uniform rectangular flow with the same flow direction and essentially the same flow rate across the width of the wire.

The headbox typically consists of a manifold distributor, flow stabilization elements and slice. The manifold distributor is a tapered header which converts the pipe flow into a rectangular flow through the slice opening with same velocity, quantity and jet thickness across the width of the wire.

The headbox serves several purposes:
(1) to provide a uniform and stable jet with a constant speed in the “machine direction” (MD) with no lateral “cross direction” (CD) components;
(2) to create controlled in the pulp suspension turbulence to disperse flocs and create a uniform suspension; and
(3) to accelerate the pulp suspension up to a high speed for fast paper production. The wire is preferably an endless wire. The wire used in the inventive method preferably has relatively high porosity in order to allow fast dewatering of the pulp suspension. The air permeability of the wire is preferably above 5000 m³/m²/hour at 100 Pa. The wires may preferably comprise at least 500 knuckles per cm², and more preferably at least 1000 knuckles per cm² to reduce fiber marking.

In some embodiments, the dry solids content of the pulp suspension applied onto the wire is in the range of 0.1-0.7 wt %, preferably in the range of 0.15-0.5 wt %, more preferably in the range of 0.2-0.4 wt %.

The pH value of the pulp suspension may typically be in the range of 4-10 preferably in the range of 5-8, and more preferably in the range of 5.5-7.5.

The temperature of the pulp suspension may typically be in the range of 30-70° C., preferably in the range of 40-60° C., and more preferably in the range of 45-55° C.

After being formed, the wet web is partially dewatered on the wire. Dewatering of the web on the wire may be performed using methods and equipment known in the art, examples include but are not limited to table roll and foils, suction boxes, friction less dewatering and ultra-sound assisted dewatering. Dewatering means that the dry solids content of the wet web is reduced compared to the dry solids content of the pulp suspension, but the dewatered web may still comprise a significant amount of water. In some embodiments, dewatering of the wet web means that the dry solids content of the dewatered web is above 1 wt % but below 15 wt %. In some embodiments, dewatering of the wet web means that the dry solids content of the dewatered web is above 1 wt % but below 10 wt %.

In some embodiments, the wire speed is >200 m/min, preferably >350 m/min, and more preferably >500 m/min.

The basis weight of the web, and the film, based on total dry weight is typically less than 100 g/m₂, preferably less than 60 g/m₂, and more preferably less than 40 g/m₂. In some embodiments, the basis weight of the web, and the film, based on total dry weight is in the range of 10-100 g/m₂, preferably in the range of 10-60 g/m₂, more preferably in the range of 20-40 g/m₂. Pinhole free films with basis weights in these ranges have been found have good oxygen barrier properties.

The invention is described herein mainly with reference to an embodiment wherein the film is formed from a single web layer comprising highly refined cellulose fibers. However, it is understood that the film may also comprise additional web layers comprising highly refined cellulose fibers. Thus, it is also possible that the formed film is formed from two or more web layers comprising highly refined cellulose fibers, such as two, three, four, five, six, or seven layers. The forming, composition and structure of each additional layer may be further characterized as described above with reference to the web.

In some embodiments, the web formed in step a) is combined with one or more additional webs to form a multiply web. The one or more additional webs may have the same composition as the web formed in step a), or different.

In some embodiments, the web formed in step a) has a higher content of unrefined or slightly refined fibers having an SR value below 30, and lower content of highly refined cellulose fibers having an SR value in the range of 80-100, than the additional webs. This helps prevent the formation of a consistency gradient in the web where highly refined cellulose fibers are collected closest to the wire and forming a barrier for efficient dewatering.

In some embodiments, the web in step a) is formed directly on the wire. However, it is also contemplated that the web in step a) is formed on top of a substrate web on the wire such that it forms a second ply of a multiply structure. The substrate web may preferably comprise less than 50% by dry weight of highly refined cellulose fibers and/or more than 10% by dry weight, preferably more than 30% by dry weight, and more preferably more than 50% by dry weight of unrefined or slightly refined cellulose fibers, based on the total dry weight of the pulp suspension.

In some embodiments, an MFC layer may be formed on top of the web formed in step a). The MFC layer may preferably be formed by curtain coating of an aqueous MFC dispersion onto the web.

In some embodiments, the method comprises combining a web formed in step a) from a pulp suspension comprising 80-100% by dry weight of highly refined cellulose fibers with a second web comprising 30-70% by dry weight of highly refined cellulose fibers to form a multiply web.

The inventive method allows for improved manufacturing of a film comprising highly refined cellulose fibers in a paper-machine type of process. The invention is based on the inventive realization that feeding the partially dewatered web from the wire into a dewatering nip formed between a suction roll, also referred to as the couch roll, and a lump breaker roll at the end of the wire allows for a significant increase of the solid content of the web, without excessive fiber/fibril picking and pinhole formation.

The suction roll according to the invention can be of any conventional type of suction roll or couch roll used for the drying of pulp and/or production of paper or paperboard.

A lump breaker roll typically is a hollow roll, optionally provided with a rubber or plastic surface. In preferred embodiments the lump breaker roll has a hard or soft rubber surface. The lump breaker roll may for example have a soft robber surface, e.g. having a P&J (Pusey & Jones) hardness of 80 P&J. Lump breaker rolls are provided in a range of diameters. The diameter of the lump breaker roll may typically depend on the width of the paper machine. A wider machine requires a larger diameter lump breaker roll for the lump breaker roll to have sufficient rigidity. Typically, the diameter of a lump breaker roll in an industrial scale paper machine may be in the range of 500 -1500 mm, preferably in the range of 800-1200 mm. Smaller scale machines or pilot plants may also have smaller diameter lump breaker rolls.

The function of the lump breaker roll is to smooth out or crush up any lumps in the web. The width of the lump breaker roll typically corresponds to the width of the suction roll. The lump breaker roll typically rests under the force of gravity on the pulp web at a point above the suction roll, but other configurations are also possible. The lump breaker roll is placed on the suction area of the couch roll. The lump breaker roll may be positioned exactly on top of the couch roll, i.e. at the 12 o'clock position of the couch roll, or it can be displaced in the machine direction such that it is placed e.g. at the 11 o'clock position or at the 1 o'clock position. The pressure of the lump breaker roll may be simply a result of the gravitational force, but the pressure may also be adjustable. The suction roll is power driven. While the lump breaker roll may also be power driven, the lump breaker roll may instead typically derive its rotation from its frictional contact with the moving web.

The combination of a suction roll and a lump breaker roll at the end of the wire gives rise to a stronger and denser web with less pinholes and better barrier properties. A higher solid of the web when entering the press section, as enabled by the combination of a suction roll and a lump breaker roll at the end of the wire, allows for the use of higher press loads in the press section and leads to less problems with shrinkage in the following drying.

In some embodiments, the dewatering nip is arranged such that the surface of the web facing the moving wire in step a) also faces the lump breaker roll in the dewatering nip in step b).

The dewatering nip may be a soft nip or a hard nip. A hard nip is formed between a couch roll and lump breaker roll having a hard surface, such as metal, or a hard plastic or rubber. A soft nip is formed between a couch roll and lump breaker roll having a soft surface such as a softer rubber surface. A soft nip may also be referred to as an extended nip, since deformation of the soft surface will lead to a larger contact area of the nip.

One of the major problems with MFC dewatering is that it forms a filter layer against the dewatering wire. In many cases this causes a consistency gradient with a high solids layer close to the wire (might be >15-18% solids) and a very low solids layer at the top (might be <8% or even much lower). It may be difficult or even impossible to pick this type of structure from the wire to the press section without damaging it. The inventors have found that this problem can be resolved by employing a felted lump breaker roll. The felted lump breaker roll is used to increase the consistency in the low solids layer at the top, making the web easier to pick from the wire to the press section.

In some embodiments, the lump breaker roll is provided with a press felt wrapped around the lump breaker roll. This way, the dewatering of the web can be made symmetric, i.e. water is removed from one side via the suction roll and from the other side via the press felt. The press felt may for example be dewatered by the use of suction boxes positioned in its loop. The press felt may be the same felt also used in a following press section, but it may also be a separate press felt.

When a press felt is used on the lump breaker roll, the lump breaker roll may preferably be a blind hole lump breaker roll. A blind hole lump breaker roll is provided with a large number of blind holes with a certain depth are drilled into the surface of the roll and designed to hold excess water. The holed are called blind holes because the bottom of the holes is not connected to the atmosphere or vacuum.

The press load in the dewatering nip should preferably be kept relatively low. In some embodiments, the press load in the dewatering nip is 10 kN/m or less, preferably in the range of 0.5 to 10 kN/m, and more preferably in the range 1 to 5 kN/m.

The introduction of a lump breaker roll in the inventive method enables the use of higher vacuum levels in the suction roll, without causing fiber/fibril picking. The vacuum level in the suction roll could be raised from todays −396 mmHg to −500 to −600 mmHg. Thus, in some embodiments, the vacuum in the suction roll is in the range of −400 to −700 mmHg, preferably in the range of −500 to −600 mmHg.

In some embodiments, the solid content of the web entering the dewatering nip is in the range of 7-13 wt %, preferably in the range of 9 to 11 wt %.

In some embodiments, the solid content of the web leaving the dewatering nip is in the range of 14-20 wt %, preferably in the range of 16 to 18 wt %.

In some embodiments, the web leaving the dewatering nip is subjected to further dewatering of the web in a press section and drying of the web in a drying section.

The optional further dewatering typically comprises pressing the web to squeeze out as much water as possible. The further dewatering may for example include passing the formed web between large rolls loaded under high pressure to squeeze out water. The removed water is typically received by a fabric or felt. In some embodiments, the dry solids content of the web after the further dewatering in the press section is in the range of 25-45 wt %, preferably in the range of 30-45 wt %, and more preferably in the range of 30-40 wt %.

The optional drying may for example include drying the web by passing the web around a series of heated drying cylinders. Drying may typically reduce the water content in the web down to a level of about 1-15 wt %, preferably to about 2-10 wt %.

The dry solids content of the final film may vary depending on the intended use of the film. For example, a film for use as a stand-alone product may have a dry solids content in the range of 85-99 wt %, preferably in the range of 90-98 wt %.

The finished film is typically collected on a reel, e.g. using a pope reel arrangement.

In some embodiments, the press section comprises at least one press nip, preferably two or three press nips.

Thanks to the introduction of a lump breaker roll in the inventive method, the press loads in the press section can be increased. In some embodiments, the press section comprises three press nips arranged sequentially in the running direction of the web, and wherein the press load in the first press nip is in the range of 8-12 kN/m, the press load in the second press nip is in the range of 18-22 kN/m, and the press load in the third press nip is in the range of 28-32 kN/m.

In some embodiments, the press section comprises at least one shoe press nip.

In some embodiments, wherein the press load in the at least one shoe press nip is in the range of 300-900 kN/m, preferably in the range of 300-600 kN/m.

In some embodiments, the press section comprises at least two shoe press nips, wherein the press load in the first shoe press nip is in the range of 300-600 kN/m, and the press load in a second shoe press nip is in the range of 600 -1600 kN/m.

The press load in the second shoe press nip is higher than the press load in the second shoe press nip.

The solid content of the web before the dewatering nip is typically around 9-11 wt %. After the dewatering nip the solid content of the web is typically 16-18 wt % and after the third press nip, the solid content of the web is typically around 25-45 wt %. This may be compared with a solid content of the web of around 23-28 wt % after the third press nip for an identical method but without the lump breaker roll. In some embodiments, the dry solids content of the web after the further dewatering in the press section is in the range of 25-45 wt %, preferably in the range of 30-45 wt %, and more preferably in the range of 30-40 wt %.

The term film as used herein refers generally to a thin continuous sheet formed material. Depending on the composition of the pulp suspension, the film can also be considered as a thin paper or even as a membrane.

The film preferably has a grammage below 100 g/m₂, preferably in the range of 10-100 g/m₂. The film is typically relatively dense. Because of the content of highly refined cellulose fibers, such as MFC, the resulting film will typically have a density of at least 800 kg/m₃, preferably at least 900 kg/m₃. Subsequent calandering may further increase the density of the obtained film to at least 950 kg/m₃, preferably at least 1050 kg/m₃. Such films have been found to be very useful as gas barrier films, e.g. in packaging applications. The films can be used to replace or reduce the need for conventional barrier films, such as synthetic polymer films or aluminum foils which reduce the recyclability of paper or paperboard packaging products. The films have high repulpability, providing for high recyclability or reusability of the films and paper or paperboard packaging products comprising the films.

In some embodiments, the obtained film comprising the highly refined cellulose fibers has a dry basis weight in the range of 10-60 g/m₂, preferably in the range of 20-40 g/m₂.

In some embodiments, the obtained film comprising the highly refined cellulose fibers has a density of at least 800 kg/m₃, preferably at least 850 kg/m₃, more preferably at least 900 kg/m₃, as measured according to standard ISO 534. Subsequent calandering may further increase the density of the obtained film to at least 950 kg/m₃, preferably at least 1050 kg/m₃.

Pinholes are microscopic holes that can appear in the web during the forming process. Examples of reasons for the appearance of pinholes include irregularities in the pulp suspension, e.g. formed by flocculation or re-flocculation of fibrils, rough dewatering fabric, uneven pulp distribution on the wire, or too low a web grammage. In some embodiments, the obtained film comprises less than 10 pinholes/m₂, preferably less than 8pinholes/m₂, and more preferably less than 2 pinholes/m₂, as measured according to standard EN 13676:2001. Most preferably, the obtained film comprises no pinholes. The measurement involves treating the film with a coloring solution (e.g. dyestuff E131 Blue in ethanol) and inspecting the surface microscopically.

The film will typically exhibit good resistance to grease and oil. Grease resistance of the film is evaluated by the KIT-test according to standard ISO 16532-2. The test uses a series of mixtures of castor oil, toluene and heptane. As the ratio of oil to solvent is decreased, the viscosity and surface tension also decrease, making successive mixtures more difficult to withstand. The performance is rated by the highest numbered solution which does not darken the sheet after 15 seconds. The highest numbered solution (the most aggressive) that remains on the surface of the paper without causing failure is reported as the “kit rating” (maximum 12). In some embodiments, the obtained film comprising the highly refined cellulose fibers has a KIT value of at least 8, preferably at least 10, as measured according to standard ISO 16532-2.

In some embodiments, the obtained film comprising the highly refined cellulose fibers has a Gurley Hill value of at least 10 000s/100 ml, preferably at least 25000 s/100 ml, and more preferably at least 40 000s/100 ml, as measured according to standard ISO 5636/6.

The film preferably has high repulpability. In some embodiments, the obtained film exhibits less than 30 %, preferably less than 20 %, and more preferably less than 10 % residues, when tested as a category II material according to the PTS-RH 021/97 test method.

In some embodiments, the obtained film comprising the highly refined cellulose fibers has an oxygen transfer rate (OTR), measured according to the standard ASTM F1927-98 at 50% relative humidity and 23° C., of less than 100 cc/m₂/24 h/atm, preferably less than 50 cc/m₂/24 h/atm, more preferably less than 20 cc/m₂/24 h/atm.

Films comprising high amounts of highly refined cellulose fibers are typically transparent or translucent to visible light. Thus, in some embodiments the film is transparent or translucent to visible light.

According to a second aspect illustrated herein, there is provided a film comprising highly refined cellulose, wherein the film is obtainable by the inventive method described with reference to the first aspect.

The inventive films are especially suited as thin packaging films when coated or laminated with one or more layers of a thermoplastic polymer. Thus, the film may preferably be coated or laminated with one or more polymer layers.

The film may be provided with a polymer layer on one side or on both sides.

The polymer layer may comprise any of the thermoplastic polymers commonly used in paper or paperboard based packaging materials in general or polymers used in liquid packaging board in particular. Examples include polyethylene (PE), polyethylene terephthalate (PET), polypropylene (PP), polylactic acid (PLA), polyglycolic acid (PGA), polyhydroxyalkanoates (PHA), starch and cellulose. Polyethylenes, especially low density polyethylene (LDPE) and high density polyethylene (HDPE), are the most common and versatile polymers used in liquid packaging board.

Thermoplastic polymers, are useful since they can be conveniently processed by extrusion coating techniques to form very thin and homogenous films with good liquid barrier properties. In some embodiments, the polymer layer comprises polypropylene or polyethylene. In preferred embodiments, the polymer layer comprises polyethylene, more preferably LDPE or HDPE.

The polymer layer may comprise one or more layers formed of the same polymeric resin or of different polymeric resins. In some embodiments the polymer layer comprises a mixture of two or more different polymeric resins. In some embodiments the polymer layer is a multilayer structure comprised of two or more layers, wherein a first layer is comprised of a first polymeric resin and a second layer is comprised of a second polymeric resin, which is different from the first polymeric resin.

In some embodiments, the polymer layer is formed by extrusion coating of the polymer onto a surface of the film. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

The basis weight of each polymer layer of the film is preferably less than 50 g/m₂. In order to achieve a continuous and substantially defect free film, a basis weight of the polymer layer of at least 8 g/m₂, preferably at least 12 g/m₂ is typically required. In some embodiments, the basis weight of the polymer layer is in the range of 8-50 g/m₂, preferably in the range of 12-50 g/m₂.

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a film comprising highly refined cellulose fibers in a paper-making machine, the method comprising the steps of:
a) forming a wet web by applying a pulp suspension comprising at least 50% by dry weight of highly refined cellulose fibers having a Schopper-Riegler (SR) value in a range of 80-100 from a headbox onto a moving wire and partially dewatering the wet web on the wire to form a partially dewatered web;
b) feeding the partially dewatered web from the wire into a dewatering nip formed between a suction roll and a lump breaker roll to further dewater the partially dewatered web;
c) optionally further dewatering the partially dewatered web from the dewatering nip in a press section; and
d) drying the partially dewatered web in a drying section to obtain a film comprising the highly refined cellulose fibers.

2. The method according to claim 1, wherein a dry solids content of the pulp suspension applied onto the wire is in a range of 0.1-0.7 wt %.

3. The method according to claim 1, wherein the highly refined cellulose fibers have an SR value in a range of 80-98.

4. The method according to claim 1, wherein the highly refined cellulose fibers have a water retention value (WRV) of at least 2.0 g/g.

5. The method according to claim 1, wherein the highly refined cellulose fibers comprises microfibrillated cellulose (MFC).

6. The method according to claim 1, wherein a wire speed of the moving wire is >200 m/min.

7. The method according to claim 1, wherein the wet web formed in step a) is combined with one or more additional webs to form a multiply web.

8. The method according to claim 1, further comprising:
combining the wet web of step a) wherein the pulp suspension comprises 80-100% by dry weight of highly refined cellulose fibers with a second web comprising 30-70% by dry weight of highly refined cellulose fibers to form a multiply web.

9. The method according to claim 1, wherein the dewatering nip is arranged such that a surface of the partially dewatered web facing the moving wire in step a) also faces the lump breaker roll in the dewatering nip in step b).

10. The method according to claim 1, wherein the lump breaker roll is provided with a press felt wrapped around the lump breaker roll.

11. The method according to claim 1, wherein a press load in the dewatering nip is 10 kN/m or less.

12. The method according to claim 1, wherein a vacuum in the suction roll is in a range of −400 to −700 mmHg.

13. The method according to claim 1, wherein a solid content of the partially dewatered web entering the dewatering nip is in a range of 7-13 wt %.

14. The method according to claim 1, wherein a solid content of the partially dewatered web leaving the dewatering nip is in a range of 14-20 wt %.

15. The method according to claim 1, wherein press section comprises at least one press nip.

16. The method according to claim 15, wherein the press section comprises three press nips arranged sequentially in a running direction of the web, and
wherein the press load in a first press nip is in a range of 8-12 kN/m, a press load in a second press nip is in a range of 18-22 kN/m, and a press load in a third press nip is in a range of 28-32 kN/m.

17. The method according to claim 15, wherein the press section comprises at least one shoe press nip.

18. The method according to claim 17, wherein press load in the at least one shoe press nip is in a range of 300-900 kN/m.

19. The method according to claim 1, wherein the dry solids content of the partially dewatered web after the further dewatering in the press section is in a range of 25-45 wt %.

20. The method according to claim 1, wherein a dry solids content of the film after the drying in the drying section is in a range of 85-99 wt %.

21. The method according to claim 1, wherein the film has a dry basis weight in a range of 10-60 g/m₂.

22. The method according to claim 1, wherein the film has a density of at least 800 kg/m₃, as measured according to standard ISO 534.

23. The method according to claim 1, wherein the film comprises less than 10 pinholes/m₂, as measured according to standard EN 13676:2001.

24. The method according to claim 1, wherein the film has a KIT value of at least 8, as measured according to standard ISO 16532-2.

25. The method according to claim 1, wherein the film fibers has a Gurley Hill value of at least 10,000 s/100 ml, as measured according to standard ISO 5636/6.

26. The method according to claim 1, wherein the film has an oxygen transfer rate (OTR), measured according to standard ASTM F1927-98 at 50% relative humidity and 23° C., of less than 100 cc/m₂/24 h/atm.
